(19) United States
(12) Patent Application Publication
(10) Pub. No.: US 2011/0099528 A1
(43) Pub. Date: Apr. 28, 2011

(54) HIGH-LEVEL SYNTHESIS APPARATUS, HIGH-LEVEL SYNTHESIS METHOD, AND COMPUTER READABLE MEDIUM

(75) Inventor: Yuichiro MIYAOKA, Kawasaki-shi (JP)

(73) Assignee: KABUSHIKI KAISHA TOSHIBA, Tokyo (JP)

(21) Appl. No.: 12/861,728

(22) Filed: Aug. 23, 2010

(30) Foreign Application Priority Data
Oct. 22, 2009 (JP) 2009-243751

(51) Int. Cl. G06F 17/50

(52) U.S. Cl. 716/104; 716/108

(57) ABSTRACT

In one embodiment, a high-level synthesis apparatus is disclosed for design of semiconductor integrated circuits. The apparatus can include a parser, a scheduler, a binder, a circuit description generator, and a margin information generator. The parser parses a behavioral description representing behavior of the semiconductor integrated circuits. The scheduler schedules operations to determine operation timing. The binder conducts binding to determine a quantity of hardware resources and a circuit configuration of the semiconductor integrated circuits based on a result of the scheduler. The circuit description generator generates a circuit description of the semiconductor integrated circuits based on results of the scheduler and the binder. The margin information generator generates margin information including a margin time indicative of a period during which there is no arithmetic operation depending on input and output signals in the semiconductor integrated circuits based on the result of the scheduler and the constraint.

### CROSS REFERENCE TO RELATED APPLICATIONS

This application is based upon and claims the benefit of priority from the prior Japanese Patent Application No. 2009-243751, filed on Oct. 22, 2009, the entire contents of which are incorporated herein by reference.

### FIELD

Embodiments described herein relate generally to a high-level synthesis apparatus, a high-level synthesis method, and a computer readable medium storing a high-level synthesis program, which are used in design of semiconductor integrated circuits such as LSI (Large Scale Integrations).

### BACKGROUND

High-level synthesis used in LSI design is a technique for generating a register transfer level (hereafter referred to as “RTL”) description from a behavioral description whose abstraction level is higher than that of the RTL description. The high-level synthesis is important to improve design productivity of the LSI.

In an ordinary high-level synthesis, the behavioral description such as a C-language, input-output information of a synthesis circuit, and constraints such as circuit area or timing are input. Then, control and data dependency in the behavioral description are analyzed. Then, based on the constraints, arithmetic operations are scheduled to be executed at the optimal timing and bound to hardware resources. Then, the RTL description is generated based on a result of the scheduling and a result of the binding.

In the ordinary high-level synthesis, a range (hereafter referred to as “synthesized module”) of a target to high-level synthesis is predetermined similarly to RTL design in which a designer writes RTL codes manually, and consequently the range of optimization is restricted to the synthesized module. Therefore, there is an issue that an optimal result cannot be obtained in P&R (Placement and Routing) process because of other modules and it becomes difficult for path delay to meet target clock period (hereafter referred to as “timing closure”). In addition, there is also an issue that routing becomes difficult because modules are crowded.

As a method for solving these issues, a technique of iterating the high-level synthesis and the placement is known (see JP-A 2004-265224 (KOKAI)). For the technique disclosed in JP-A 2004-265224 (KOKAI), however, it is necessary to synthesize the whole chip or an extremely large circuit collectively as the synthesized module. Therefore, operation time for the high-level synthesis is increased. In addition, since each high-level synthesis result is changed by feeding back a placement result, it is necessary to repeat the high-level synthesis and the placement each time. Therefore, design period of the LSI is prolonged.

### BRIEF DESCRIPTION OF THE DRAWINGS

FIG. 1 is a block diagram showing a configuration of a high-level synthesis apparatus 1 according to a first embodiment.

FIG. 2 is a block diagram showing functions implemented by a processor 10 of FIG. 1.

FIG. 3 is a flow chart showing a procedure of a high-level synthesis operation according to the first embodiment.

FIGS. 4A and 4B are schematic diagrams showing examples of a behavioral description and a temporary constraint given to execute the high-level synthesis operation shown in FIG. 3.

FIG. 5 is a schematic diagram showing an example of a result of the scheduling obtained at a scheduling step shown in FIG. 3.

FIG. 6 is a schematic diagram showing an example of image information according to a modification of the first embodiment.

FIGS. 7A and 7B are schematic diagrams showing examples of a behavioral description and timing constraints given to execute the high-level synthesis operation according to a second embodiment.

FIG. 8 is a schematic diagram showing an example of a result of the scheduling obtained at the scheduling step (S303) in the high-level synthesis operation according to the second embodiment.

FIG. 9 is a schematic diagram showing an example of image information according to a modification of the second embodiment.

FIG. 10 is a block diagram showing functions implemented by the processor 10 of FIG. 1 according to a third embodiment.

FIG. 11 is a flow chart showing a procedure of the high-level synthesis operation according to the third embodiment.

FIG. 12 is a schematic diagram showing an example of image information according to a modification of the third embodiment.

### DETAILED DESCRIPTION

In one embodiment, a high-level synthesis apparatus for design of semiconductor integrated circuits such as LSI is disclosed. The apparatus can include a parser, a scheduler, a binder, a circuit description generator, and a margin information generator. The parser is configured to parse a behavioral description representing behavior of a semiconductor integrated circuit. The scheduler is configured to schedule operations in order to determine operation timing in which each arithmetic operation in the behavioral description meets timing constraints of the semiconductor integrated circuit based on a result parsed by the parser. The binder is configured to conduct binding to determine a quantity of hardware resources and a circuit configuration of the semiconductor integrated circuit corresponding to the behavioral description, based on a result of the scheduler. The circuit description generator is configured to generate a circuit description of the semiconductor integrated circuit corresponding to the behavioral description, based on the result of the scheduler and a result of the binder. The margin information generator is configured to generate margin information including a margin time indicative of a period during which there is no arithmetic operation depending on an input signal and an output signal in the semiconductor integrated circuit corresponding to the behavioral description, based on the result of the scheduler and the constraint.

Embodiments will now be explained with reference to the accompanying drawings.

### First Embodiment

A first embodiment will now be explained. The first embodiment is an example of a high-level synthesis apparatus which outputs margin information regarding timing relaxation in addition to a circuit description.

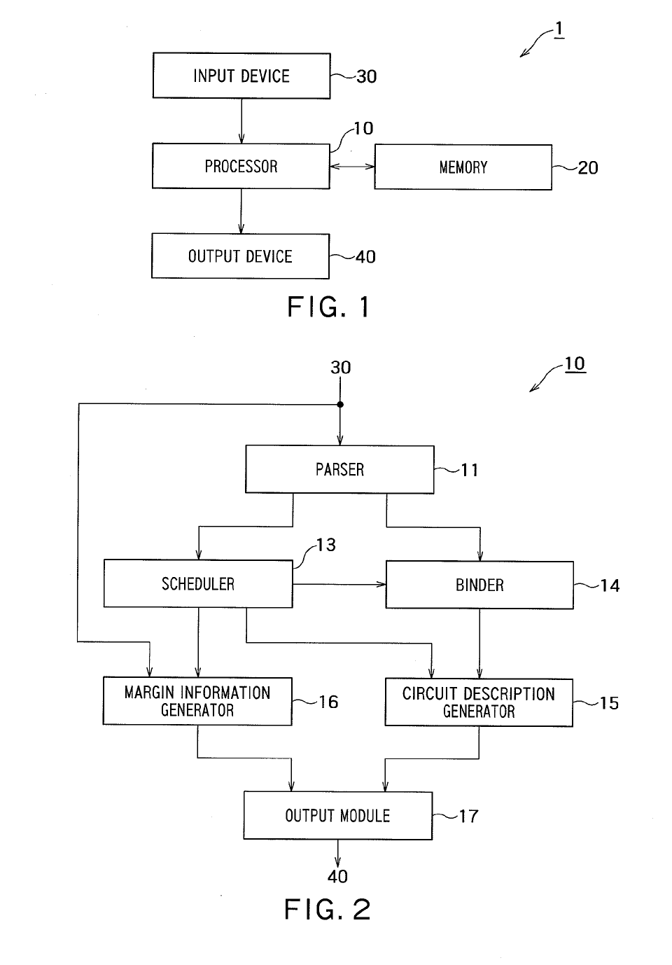

A configuration of a high-level synthesis apparatus according to the first embodiment will now be explained. FIG. 1 is a block diagram showing a configuration of a high-level synthesis apparatus 1 according to the first embodiment. FIG. 2 is a block diagram showing functions implemented by a processor 10 of FIG. 1.

As shown in FIG. 1, the high-level synthesis apparatus 1 according to the first embodiment includes a processor 10, a memory 20, an input device 30, and an output device 40. The processor 10 is connected to the memory 20, the input device 30, and the output device 40. The processor 10 executes a high-level synthesis program stored in the memory 20 to implement functions required for high-level synthesis operation according to the first embodiment. The input device 30 inputs a behavioral description which represents behavior of a semiconductor integrated circuit and information required for the high-level synthesis operation such as a constraint including timing constraints of the semiconductor integrated circuit. The output device 40 outputs a result of the high-level synthesis operation. For example, the processor 10 is a CPU (Central Processing Unit), the memory 20 is a computer-readable medium such as a hard disc drive or a flash memory, the input device 30 is a keyboard, and the output device 40 is a liquid crystal display.

As shown in FIG. 2, the processor 10 implements a parser 11, a scheduler 13, a binder 14, a circuit description generator 15, a margin information generator 16, and an output module 17.

The parser 11 parses the behavioral description which represents behavior of the semiconductor integrated circuit to generate an abstract syntax tree. Then, the parser 11 modifies and optimizes the abstract syntax tree, controls generation of a control data flow (hereafter referred to as “CDFG (Control and Data Flow Graph)”), and analyzes data dependency.

The scheduler 13 schedules operations in order to determine operation timing in which each arithmetic operation in the behavioral description meets timing constraints of the semiconductor integrated circuit based on a result parsed by the parser 11.

The binder 14 conducts binding to determine a quantity of hardware resources and a circuit configuration of the semiconductor integrated circuit corresponding to the behavioral description, based on a result of the scheduling of the scheduler 13. For example, the binder 14 determines the amount of the computing units and the amount of registers as the quantity of the hardware resources. Then, the binder 14 generates a FSM (Finite State Machine) and a multiplexer to determine the circuit configuration.

The circuit description generator 15 generates a circuit description such as the RTL description of the semiconductor integrated circuit corresponding to the behavioral description based on the result of the scheduling and the result of the binding of the binder 14.

The margin information generator 16 generates margin information including a time (hereafter referred to as “margin time”) based on the result of the scheduling and the timing constraints. The margin time indicates a period during which there is no arithmetic operation depending on an input signal and an output signal in the semiconductor integrated circuit corresponding to the behavioral description. That is, the margin time represents the degree of margin time in the design of the semiconductor integrated circuit. In the other word, the margin time represents period in which the operation timing can be relaxed.

The output module 17 outputs the circuit description generated by the circuit description generator 15 and the margin information generated by the margin information generator 16.

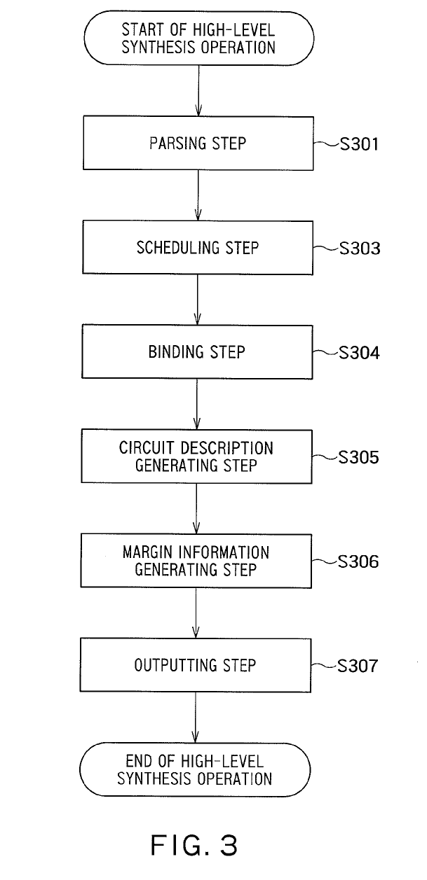

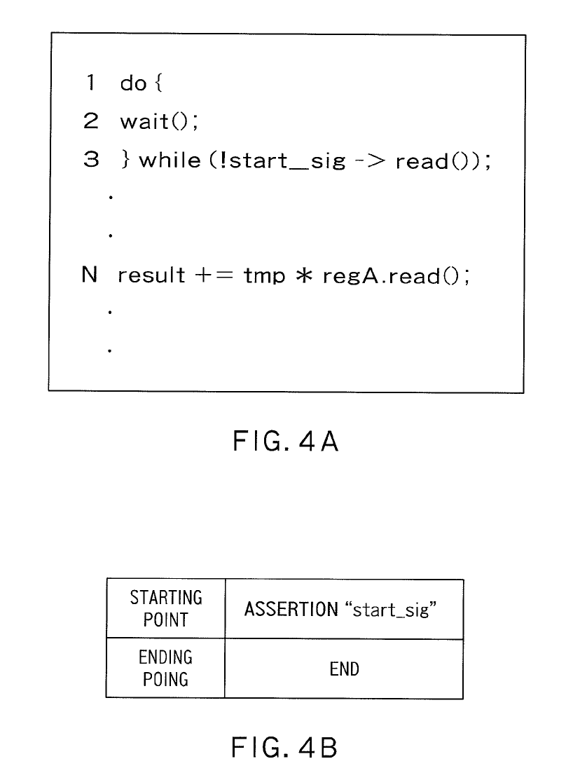

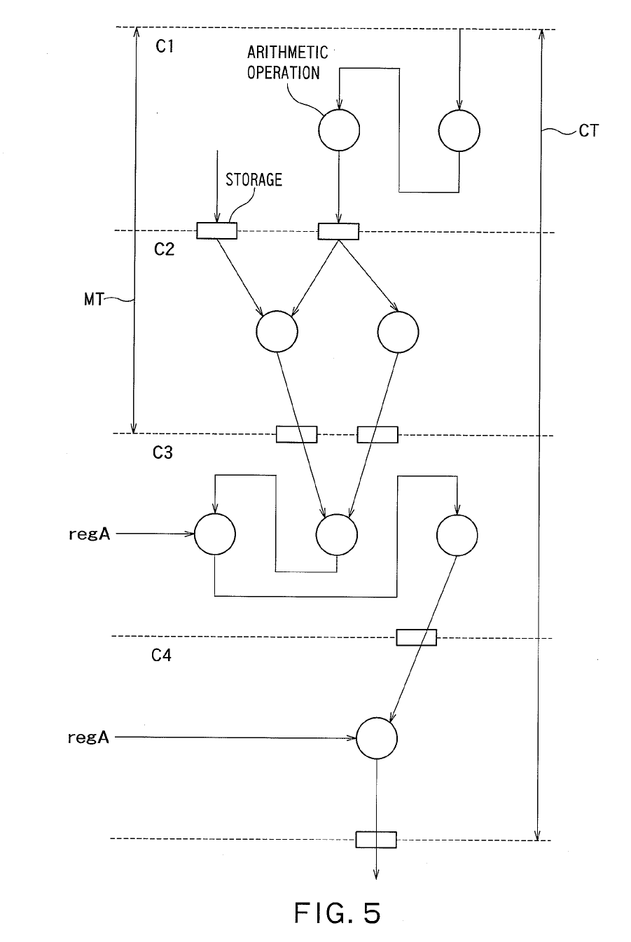

High-level synthesis operation according to the first embodiment will now be explained. FIG. 3 is a flow chart showing a procedure of the high-level synthesis operation according to the first embodiment. FIGS. 4A and 4B are schematic diagrams showing examples of the behavioral description and the timing constraints given to execute the high-level synthesis operation shown in FIG. 3. FIG. 5 is a schematic diagram showing an example of a result of the scheduling obtained at a scheduling step shown in FIG. 3.

The high-level synthesis operation according to the first embodiment shown in FIG. 3 is started when the behavioral description shown in FIG. 4A and the timing constraints shown in FIG. 4B are given. As shown in FIG. 4B, the timing constraints include access constraints which indicates an accessible period capable of accessing a register used as the hardware resources. The accessible period includes a starting point and an ending point. The behavioral description in FIG. 4A indicates that the arithmetic operation is started after a start signal (start_sig) has become “1”. The constraint in FIG. 4B indicates that the register can be accessed at any time after the start signal (start_sig) has been asserted (in other words, the result of arithmetic operation using an input signal (regA) is the same at any time after the start signal (start_sig) has become “1”).

### <Parsing Step (S301) in FIG. 3>

The parser 11 parses the behavioral description shown in FIG. 4A to generate the abstract syntax tree, modifies and optimizes the abstract syntax tree, controls the generation of the CDFG, and analyzes the data dependency.

### <Scheduling Step (S303) in FIG. 3>

The scheduler 13 conducts scheduling to determine the operation timing in which each arithmetic operation involved in the behavioral description is operated to meet the timing constraints shown in FIG. 4B are satisfied, based on the parsed result obtained at the parsing step (S301).

### <Binding Step (S304) in FIG. 3>

The binder 14 conducts binding to determine the quantity of the hardware resources and the circuit configuration based on the result of the scheduling obtained at the scheduling step (S303).

### <Circuit Description Generating Step (S305) in FIG. 3>

The circuit description generator 15 generates the circuit description such as the RTL description based on the result of the scheduling and the result of the binding obtained at the binding step (S304).

### <Margin Information Generating Step (S306) in FIG. 3>

The margin information generator 16 generates margin information including the margin time based on the result of the scheduling and the timing constraints shown in FIG. 4B. Here, the margin information generator 16 calculates a difference between the starting point of the accessible period in the access constraints and a first cycle of an input signal, in which the input signal is first given to generate the margin information including the margin time equal to a calculating result. For example, in the timing constraints shown in FIG. 4B, the register can be accessed from a first cycle (C1). In a result of the scheduling shown in FIG. 5, an input signal (regA) is given in a third cycle (C3) and a fourth cycle (C4) after the start signal (start_sig) has become “1.” In this case, the margin information generator 16 calculates a difference between the starting point (C1) of the accessible period in the access constraints and a cycle (C3) in which the input signal (regA) is first given to generate margin information including two cycles equal to the calculating result as the margin time MT. In other words, the margin time is the period in which the timing can be relaxed. That is, the margin time indicates the degree of the margin time.

### <Outputting Step (S307) in FIG. 3>

The output module 17 outputs the circuit description generated at the circuit description generating step (S305) and the margin information generated at the margin information generating step (S306).

Conventionally, the timing constraints given by the designer have been utilized only for generating the RTL description. As a result, the design period of the semiconductor integrated circuit has been prolonged. On the other hand, in the first embodiment, the timing constraints given by the designer are utilized for generating the margin information as well, and the margin information is output together with the circuit description such as the RTL description. Therefore, the designer can easily know the degree of the margin time in the circuit description without complicated calculations. As a result, according to the first embodiment, the design period of the semiconductor integrated circuit is shortened.

Conventionally, the high-level synthesis and the placement have been repeated. As a result, the operation time of the high-level synthesis has been prolonged. On the other hand, in the first embodiment, the circuit description and the margin information are generated by conducting the high-level synthesis operation one time. Therefore, it is not necessary to repeat the high-level synthesis and the placement. As a result, the operation time of the high-level synthesis is shortened.

In the first embodiment, the example in which the margin information is output together with the circuit description has been explained. However, the scope of the present invention is not limited to this example. For example, the output module 17 may output information obtained by adding the margin time MT to the result of the scheduling such as the CDFG, in addition to the circuit description, as image information (see FIG. 5).

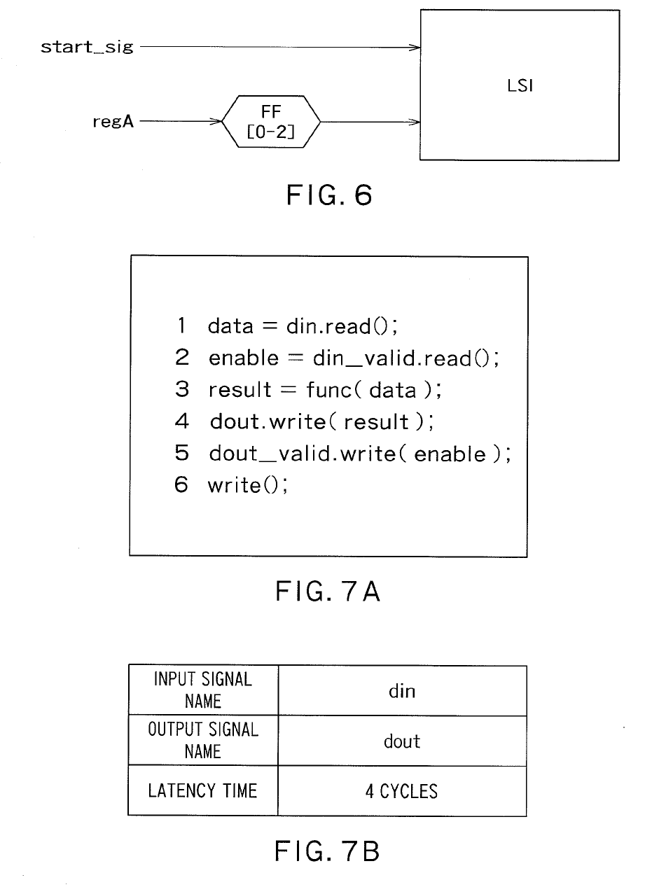

In the first embodiment, an example in which the margin information including the margin time is generated has been explained. However, the scope of the present invention is not restricted to this example. For example, the margin information generator 16 may generate margin information including a module (for example, a flip-flop) which can be inserted during the margin time, as image information (see FIG. 6). FIG. 6 is a schematic diagram showing an example of image information according to a modification of the first embodiment. The image information shown in FIG. 6 indicates that flip-flops of 0 to 2 stages can be inserted on a route of an input signal (regA).

Alternatively, the margin information generator 16 may generate image information indicating that other timing relaxation means such as multi-cycle path specification should be applied instead of flip-flop insertion.

### Second Embodiment

A second embodiment will now be explained. In the first embodiment, an example in which the timing constraints include the access constraints regarding the accessible period to the register has been explained. In the second embodiment, however, an example in which the timing constraints include latency constraints regarding a latency time of the output signal to the input signal will be explained. Description regarding contents similar to those in the first embodiment will not be repeated.

A high-level synthesis apparatus according to the second embodiment has a configuration similar to that in the first embodiment.

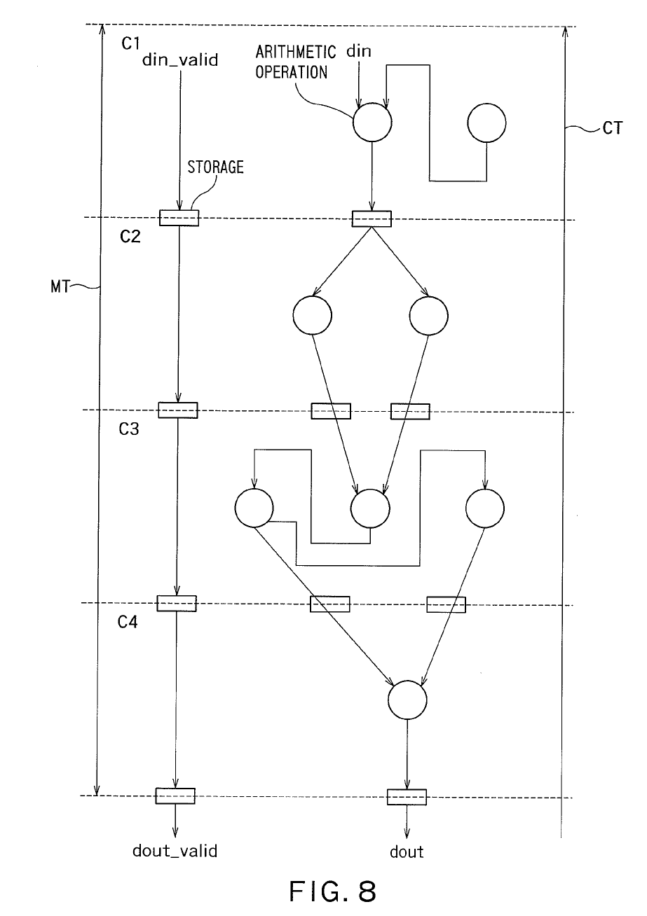

A high-level synthesis operation according to the second embodiment will now be explained. FIGS. 7A and 7B are schematic diagrams showing examples of a behavioral description and timing constraints given to execute the high-level synthesis operation according to the second embodiment. FIG. 8 is a schematic diagram showing an example of a result of the scheduling obtained at the scheduling step (S303) in the high-level synthesis operation according to the second embodiment.

The high-level synthesis operation according to the second embodiment is conducted according to the procedure shown in FIG. 3.

The high-level synthesis operation according to the second embodiment is started when a behavioral description shown in FIG. 7A and timing constraints shown in FIG. 7B are given. As shown in FIG. 7B, the timing constraints include latency constraints which indicate a latency time from an input signal to an output signal. The latency constraints include an input signal name, an output signal name, and the latency time. The behavioral description shown in FIG. 7A shows behavior for receiving an input signal (din, din_valid), operating arithmetic operation, and outputting an output signal (dout, dout_valid). The timing constraints shown in FIG. 7B indicate that the latency time (the number of operation clock cycles) between the input signal (din) and the output signal (dout) is four cycles (in other words, it is necessary to generate the output signal within six cycles after the input signal is received).

Steps other than the margin information generating step (S306) are the same as those in the first embodiment. Therefore, the margin information generating step (S306) will be explained.

### <Margin Information Generating Step (S306) in FIG. 3>

The margin information generator 16 generates margin information including the margin time based on the result of the scheduling and the timing constraints. Here, when the total number of cycles in the result of the scheduling is less than or equal to the latency time in the latency constraints (i.e., the semiconductor integrated circuit satisfies the timing constraints), the margin information generator 16 generates margin information including the margin time equal to the latency time. For example, in the result of the scheduling shown in FIG. 8, the total number of cycles is six cycles. Under the timing constraints shown in FIG. 7B, the latency time is four cycles. In this case, the margin information generator 16 generates margin information including four cycles as the margin time.

According to the second embodiment, effects similar to those in the first embodiment can be obtained even in the case where the latency constraints are given.

In the second embodiment, the example in which the margin information is output together with the circuit description has been explained. However, the scope of the present invention is not limited to this example. For example, the output module 17 may output information obtained by adding the margin time MT to the result of the scheduling such as the CDFG, in addition to the circuit description, as image information (see FIG. 8).

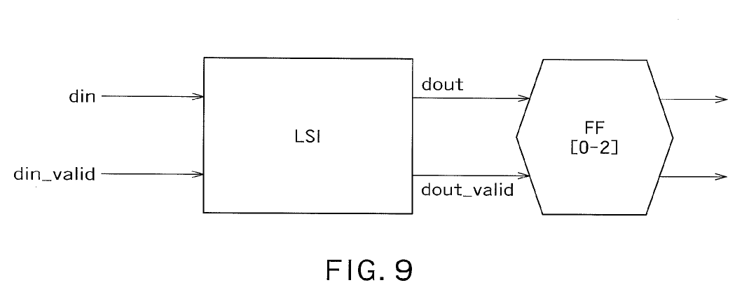

In the second embodiment, an example in which the margin information including the margin time is generated has been explained. However, the scope of the present invention is not restricted to this example. For example, the margin information generator 16 may generate margin information including a module (for example, a flip-flop) which can be inserted during the margin time, as image information (see FIG. 9). FIG. 9 is a schematic diagram showing an example of image information according to a modification of the second embodiment. The image information shown in FIG. 9 indicates that flip-flops of 0 to 2 stages can be inserted on a route of output signals (dout, dout_valid) of an LSI which receives input signals (din, din_valid). The image information shown in FIG. 9 indicates that it is necessary to insert the flip-flop including the same number of stages on a route of the output signal (dout) and a route of the output signal (dout_valid). Alternatively, the margin information generator 16 may generate image information indicating that other timing relaxation means such as multi-cycle path specification should be applied instead of flip-flop insertion.

### Third Embodiment

A third embodiment will now be described. In the first and second embodiments, examples in which the high-level synthesis apparatus outputs the margin information regarding the margin time have been described. In the third embodiment, however, an example in which the high-level synthesis apparatus outputs margin information regarding a margin area will be explained. Description regarding contents similar to those in the first and second embodiments will not be repeated.

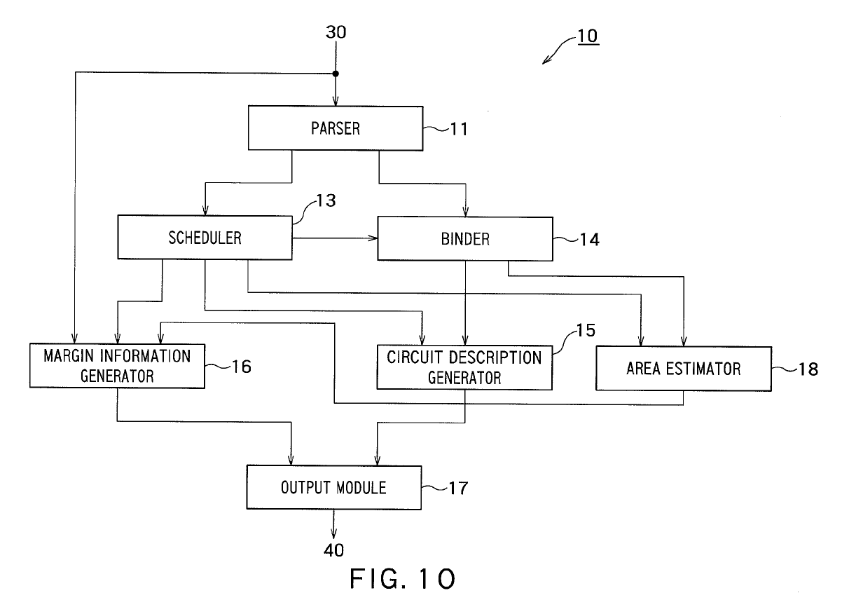

A configuration of a high-level synthesis apparatus according to the third embodiment will now be explained. FIG. 10 is a block diagram showing functions implemented by a processor 10 of FIG. 1 according to the third embodiment.

A high-level synthesis apparatus 1 according to the third embodiment has a configuration similar to that in the first embodiment (see FIG. 1).

As shown in FIG. 10, the processor 10 implements a parser 11, a scheduler 13, a binder 14, a circuit description generator 15, a margin information generator 16, an output module 17, and an area estimator 18.

The parser 11, the scheduler 13, the binder 14, the circuit description generator 15, and the output module 17 are similar to those in the first embodiment (see FIG. 2).

The area estimator 18 estimates an area of a semiconductor integrated circuit based on the results of the scheduling and the binding.

The margin information generator 16 generates margin information including margin time based on the result of the scheduling and the timing constraints (the access constraints or the latency constraints), and a margin area which indicates the degree of the margin area of the semiconductor integrated circuit based on the estimated area estimated by the area estimator 18 and the area constraint.

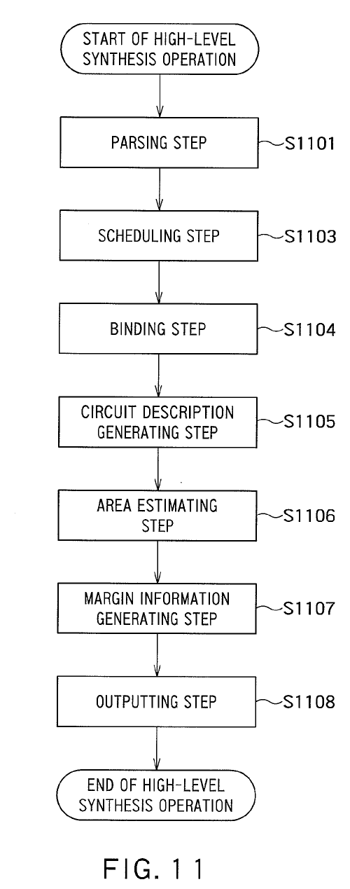

High-level synthesis operation according to the third embodiment will now be explained. FIG. 11 is a flow chart showing a procedure of the high-level synthesis operation according to the third embodiment.

The high-level synthesis operation according to the third embodiment shown in FIG. 11 is started when the area constraint of the semiconductor integrated circuit is given in addition to the behavioral description shown in FIG. 4A and the timing constraints (access constraints) shown in FIG. 4B or the behavioral description shown in FIG. 7A and the timing constraints (latency constraints) shown in FIG. 7B.

### <Parsing Step (S1101) to Circuit Description Generating Step (S1105) in FIG. 11>

These steps are similar to those in the first embodiment (see <Parsing step (S301) to circuit description generating step (S305) in FIG. 3>).

### <Area Estimating Step (S1106) in FIG. 11>

The area estimator 18 estimates the area of the semiconductor integrated circuit corresponding to the circuit description generated at the circuit description generating step (S1105), based on the result of the scheduling obtained at the scheduling step (S1103) and the result of the binding obtained at the binding step (S1104).

### <Margin Information Generating Step (S1107) in FIG. 11>

The margin information generator 16 generates margin information including margin time based on the result of the scheduling and the timing constraints, and the margin area based on the estimated area obtained at the area estimating step (S1106) and the area constraint. For example, the margin information generator 16 operates the arithmetic operation represented as “Amargin={Aconst−Aest}/Aff” (where Amargin is the margin area, Aconst is the area constraint, Aest is the estimated area, and Aff is the area of the flip-flop) to generate margin information which includes the margin area indicating the maximum number of flip-flops which can be inserted.

### <Outputting Step (S1108) in FIG. 11>

The step is similar to that in the first embodiment (see <Outputting step (S307) in FIG. 3>).

In the third embodiment, the high-level synthesis apparatus 1 outputs margin information regarding the area as well, in addition to the margin information regarding the timing relaxation. Therefore, the desinger can easily know the degree of the margin area of the semiconductor integrated circuit corresponding to the RTL description in addition to the degree of the margin time in the circuit description without complicated calculations. As a result, according to the third embodiment, the design of the semiconductor integrated circuit which is short in latency and small in area is facilitated.

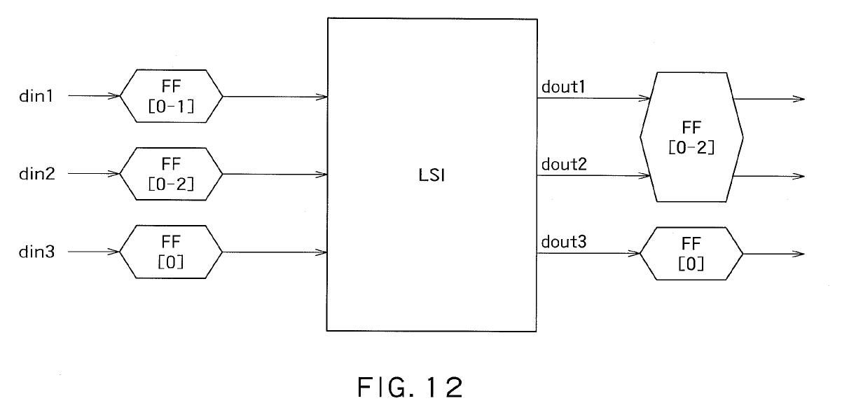

In the third embodiment, an example in which the margin information including the margin time and the margin area is generated has been explained. However, the scope of the present invention is not restricted to this example. For example, the margin information generator 16 may take the margin time and the margin area into consideration to generate margin information including a module (for example, a flip-flop) which can be inserted, as image information (see FIG. 12). FIG. 12 is a schematic diagram showing an example of image information according to a modification of the third embodiment. The image information shown in FIG. 12 indicates that flip-flops of 0 or 1 stage can be inserted on a route of an input signal (din1), flip-flops of 0 to 2 stages can be inserted on a route of an input signal (din2), and flip-flops of 0 to 2 stages can be inserted on a route of output signals (dout1, dout2). Furthermore, FIG. 12 indicates that it is necessary to insert flip-flops of the same number of stages on the route of the output signal (dout1) and the route of the output signal (dout2).

At least a portion of high-level synthesis apparatus according to the above-described embodiments may be composed of hardware or software. When at least a portion of the high-level synthesis apparatus is composed of software, a program for executing at least some functions of the high-level synthesis apparatus may be stored in a recording medium, such as a flexible disk or a CD-ROM, and a computer may read and execute the program. The recording medium is not limited to a removable recording medium, such as a magnetic disk or an optical disk, but it may be a fixed recording medium, such as a hard disk or a memory.

In addition, the program for executing at least some functions of the high-level synthesis apparatus according to the above-described embodiment may be distributed through a communication line (which includes wireless communication) such as the Internet. In addition, the program may be encoded, modulated, or compressed and then distributed by wired communication or wireless communication such as the Internet. Alternatively, the program may be stored in a recording medium, and the recording medium having the program stored therein may be distributed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the sprit of the inventions. The accompanying claims and their equivalents are intended to cover such forms or modifications as would fall within the scope and sprit of the invention.

1. A high-level synthesis apparatus comprising:
a parser configured to parse a behavioral description representing behavior of a semiconductor integrated circuit;
a scheduler configured to schedule operations in order to determine an operation timing when each arithmetic operation in the behavioral description meets design constraints of the semiconductor integrated circuit based on a result of the parser;
a binder configured to determine a quantity of hardware resources and a circuit configuration of the semiconductor integrated circuit corresponding to the behavioral description, based on a result of the scheduler;
a circuit description generator configured to generate a circuit description of the semiconductor integrated circuit corresponding to the behavioral description, based on the result of the scheduler and a result of the binder; and
a margin information generator configured to generate margin information comprising a margin time indicative of a period during which there is no arithmetic operation depending on an input signal and an output signal in the semiconductor integrated circuit corresponding to the behavioral description, based on the result of the scheduler and the design constraints.

2. The apparatus of claim 1, wherein
the design constraints comprise a timing constraint for an accessible period for accessing a register used as the hardware resources, and
the margin information generator is configured to generate the margin information comprising the margin time equal to a difference between a starting point of the accessible period and a first cycle of the input signal.

3. The apparatus of claim 1, wherein
the design constraints comprise a timing constraint for a latency time from the input signal to the output signal, and
the margin information generator is configured to generate the margin information comprising the margin time equal to the latency time when a total number of cycles in the result of the scheduler is less than or equal to the latency time.

4. The apparatus of claim 1, further comprising an area estimator configured to estimate an area of the semiconductor integrated circuit corresponding to the behavioral description based on the results of the scheduler and the binder, wherein
the design constraints comprise an area constraint of the semiconductor integrated circuit corresponding to the behavioral description, and
the margin information generator is configured to generate the margin information further comprising a margin area based on an estimated area estimated by the area estimator and the area constraint.

5. The apparatus of claim 4, wherein the margin information generator is configured to generate the margin information comprising the margin area equal to a difference between the area constraint and the estimated area per an unit area of the hardware resources.

6. The apparatus of claim 2, further comprising an area estimator configured to estimate an area of the semiconductor integrated circuit corresponding to the behavioral description based on the results of the scheduler and the binder, wherein
the design constraints comprise an area constraint of the semiconductor integrated circuit corresponding to the behavioral description, and
the margin information generator is configured to generate the margin information further comprising a margin area based on an estimated area estimated by the area estimator and the area constraint.

7. The apparatus of claim 6, wherein the margin information generator is configured to generate the margin information comprising the margin area equal to a difference between the area constraint and the estimated area per an unit area of the hardware resources.

8. The apparatus of claim 3, further comprising an area estimator configured to estimate an area of the semiconductor integrated circuit corresponding to the behavioral description based on the results of the scheduler and the binder, wherein
the design constraints comprise an area constraint of the semiconductor integrated circuit corresponding to the behavioral description, and
the margin information generator is configured to generate the margin information further comprising a margin area based on an estimated area estimated by the area estimator and the area constraint.

9. The apparatus of claim 8, wherein the margin information generator is configured to generate the margin information comprising the margin area equal to a difference between the area constraint and the estimated area per an unit area of the hardware resources.

10. A high-level synthesis method comprising:
parsing a behavioral description representing behavior of a semiconductor integrated circuit;
scheduling operations in order to determine an operation timing when each arithmetic operation in the behavioral description meets design constraints of the semiconductor integrated circuit based on a parsed result;
determining a quantity of hardware resources and a circuit configuration of the semiconductor integrated circuit corresponding to the behavioral description, based on a result of the scheduling;
generating a circuit description of the semiconductor integrated circuit corresponding to the behavioral description, based on the result of the scheduling and a result of the determining; and
generating margin information comprising a margin time indicative of a period during which there is no arithmetic operation depending on an input signal and an output signal in the semiconductor integrated circuit corresponding to the behavioral description, based on the result of the scheduling and the design constraints.

11. The method of claim 10, wherein
the design constraints comprise a timing constraint for an accessible period for accessing a register used as the hardware resources, and
the margin information comprises the margin time equal to a difference between a starting point of the accessible period and a first cycle of the input signal.

12. The method of claim 10, wherein
the constraints comprise a timing constraint for a latency time from the input signal to the output signal, and
the margin information comprises the margin time equal to the latency time when a total number of cycles in the result of the scheduling is less than or equal to the latency time.

13. The method of claim 10, further comprising estimating an area of the semiconductor integrated circuit corresponding to the behavioral description based on the results of the scheduling and the determining, wherein
the design constraints comprise an area constraint of the semiconductor integrated circuit corresponding to the behavioral description, and
the margin information further comprises a margin area based on an estimated area and the area constraint.

14. The method of claim 13, wherein the margin information comprising the margin area equal to a difference between the area constraint and the estimated area per an unit area of the hardware resources is generated.

15. The method of claim 11, further comprising estimating an area of the semiconductor integrated circuit corresponding to the behavioral description based on the results of the scheduling and the determining, wherein
the design constraints comprise an area constraint of the semiconductor integrated circuit corresponding to the behavioral description, and
the margin information further comprises a margin area based on an estimated area and the area constraint.

16. The method of claim 15, wherein the margin information comprises the margin area equal to a difference between the area constraint and the estimated area per a unit area of the hardware resources.

17. The method of claim 12, further comprising estimating an area of the semiconductor integrated circuit corresponding to the behavioral description based on the results of the scheduling and the determining, wherein
the design constraint comprises an area constraint of the semiconductor integrated circuit corresponding to the behavioral description, and
the margin information further comprises a margin area based on an estimated area and the area constraint.

18. The method of claim 17, wherein the margin information comprises the margin area equal to a difference between the area constraint and the estimated area per an unit area of the hardware resources.

19. A computer readable medium storing a high-level synthesis program, configured to cause a computer to:
parse a behavioral description representing behavior of a semiconductor integrated circuit;
schedule operations in order to determine operation timing in which each arithmetic operation in the behavioral description meets design constraints of the semiconductor integrated circuit based on a parsed result;
determine a quantity of hardware resources and a circuit configuration of the semiconductor integrated circuit corresponding to the behavioral description, based on a result of the scheduling;
generate a circuit description of the semiconductor integrated circuit corresponding to the behavioral description, based on the result of the scheduling and a result of the binding; and
generate margin information comprising a margin time indicative of a period during which there is no arithmetic operation depending on an input signal and an output signal in the semiconductor integrated circuit corresponding to the behavioral description, based on the result of the scheduling and the design constraints.

20. The medium of claim 19, wherein
the design constraints comprise a timing constraint for an accessible period for accessing a register used as the hardware resources, and
the margin information comprises the margin time equal to a difference between a starting point of the accessible period and a first cycle of the input signal.
